(19) United States
(12) Patent Application Publication
(10) Pub. No.: US 2026/0285712 A1
(43) Pub. Date: Sep. 24, 2026

(54) WATER TREATMENT FACILITY AND WATER TREATMENT METHOD

(71) Applicant: ORGANO CORPORATION, Tokyo (JP)

(72) Inventors: Tsukasa KONDO, Tokyo (JP); Kenji SUGIHARA, Tokyo (JP)

(73) Assignee: ORGANO CORPORATION, Tokyo (JP)

(21) Appl. No.: 19/479,899

(22) PCT Filed: Apr. 24, 2024
(86) PCT No.: PCT/JP2024/016085

§ 371 Date: Oct. 29, 2025

(30) Foreign Application Priority Data
May 2, 2023 (JP) 2023-076093

(51) Int. Cl. C02F 1/42; C02F 1/32; C02F 1/72

(52) U.S. Cl. CPC C02F 1/42; C02F 1/32; C02F 1/72; C02F 2001/425

(57) ABSTRACT

A water treatment apparatus and a water treatment method are provided in which elution of a catalytic metal from a catalytic metal-supported resin into ultrapure water can be prevented. A hydrogen peroxide treatment device is provided with a hydrogen peroxide removal means for removing hydrogen peroxide, wherein the hydrogen peroxide removal means includes a resin tower packed with a catalytic metal-supported resin in which a platinum group metal catalyst is supported on an anion exchange resin carrier, and a cation exchange resin, and wherein an amount of the cation exchange resin packed in the resin tower corresponds to a layer height of 30 cm or more.

### TECHNICAL FIELD

The present invention relates to a water treatment facility and a water treatment method.

### BACKGROUND ART

As one of the methods for removing organic matter from water to be treated, there is a method in which ultraviolet light is irradiated onto the water using an ultraviolet oxidation device; however, it is known that peroxides, such as hydrogen peroxide, are generated when the water is irradiated with ultraviolet light. There is a known method for removing these peroxides that uses a catalytic metal-supported resin (see, for example, Patent Document 1).

### PRIOR ART DOCUMENT

### Patent document

Patent Document 1: JP 2011-194402 A

### SUMMARY OF THE INVENTION

### Problems to be Solved by the Invention

Patent Document 1 discloses that a catalytic metal-supported resin and an anion exchange resin are packed in the same tower, and that a cation exchange resin may also be included in addition to the catalytic metal-supported resin and the anion exchange resin.

However, when water is passed through the catalytic metal-supported resin, the catalytic metal may elute. Since the catalytic metal is adsorbed by the cation exchange resin, if the cation exchange resin is not packed or is insufficiently packed, the catalytic metal may elute into ultrapure water.

It is an object of the present invention to provide a water treatment apparatus and a water treatment method capable of removing or reducing the catalytic metal that has eluted into the treated water.

### Means for Solving the Problems

An aspect of the present invention provides a hydrogen peroxide treatment device provided with a hydrogen peroxide removal means for removing hydrogen peroxide from water to be treated,
wherein the hydrogen peroxide removal means comprises a resin tower packed with a catalytic metal-supported resin in which a platinum group metal catalyst is supported on an anion exchange resin carrier, and a cation exchange resin, and wherein an amount of the cation exchange resin packed in the resin tower corresponds to a layer height of 30 cm or more.

An aspect of the present invention provides a water treatment apparatus comprising a pretreatment system, a primary pure water system, and a secondary pure water production system,
wherein the secondary pure water production system comprises the hydrogen peroxide treatment device according to any one of claims 1 to 6, and
an ultraviolet oxidation device provided upstream of the hydrogen peroxide treatment device; and
wherein hydrogen peroxide-containing water to be treated by the hydrogen peroxide treatment device is the treated water treated by the ultraviolet oxidation device.

An aspect of the present invention provides a hydrogen peroxide treatment method for treating hydrogen peroxide in water to be treated using a hydrogen peroxide treatment device provided with a hydrogen peroxide removal means for removing hydrogen peroxide,
wherein the hydrogen peroxide removal means comprises a resin tower packed with a catalytic metal-supported resin in which a platinum group metal catalyst is supported on an anion exchange resin carrier, and a cation exchange resin, and wherein an amount of the cation exchange resin packed in the resin tower corresponds to a layer height of 30 cm or more.

### Advantageous Effects of the Invention

According to the present invention, a water treatment apparatus and a water treatment method capable of removing or reducing the catalytic metal that has eluted into the treated water can be provided.

### BRIEF DESCRIPTION OF THE DRAWINGS

FIG. 1 is a schematic diagram of a water treatment apparatus according to one embodiment of the present invention.

FIG. 2 is a schematic diagram illustrating one embodiment of a stacked configuration in a resin tower having neither a water collection pipe nor a strainer.

FIG. 3 is a schematic diagram illustrating one embodiment of a stacked configuration in a resin tower having a water collection pipe.

FIG. 4 is a schematic diagram illustrating one embodiment of a stacked configuration in a resin tower having a strainer.

FIG. 5 is a graph illustrating the catalytic metal concentration in the outlet water from each column in Examples 1 and 2 and Comparative Example 1.

FIG. 6 is a graph illustrating the relationship between R-OH (%) of the catalytic metal-supported resin (carrier resin) and the decomposition efficiency of H₂O₂ in Reference Example 1.

### MODES FOR CARRYING OUT THE INVENTION

The hydrogen peroxide treatment device of the present invention treats, as water to be treated, water that has been rendered hydrogen peroxide-containing by treatment with an ultraviolet oxidation device installed at a preceding stage.

The hydrogen peroxide treatment device is equipped with a hydrogen peroxide removal means for removing hydrogen peroxide. The hydrogen peroxide removal means is provided with a resin tower, and the provided resin tower is packed with a catalytic metal-supported resin in which a platinum group catalyst is supported on a carrier of an anion exchange resin, and a cation exchange resin.

Since the catalytic metal-supported resin and the cation exchange resin are packed in the same resin tower, the catalytic metal eluted from the catalytic metal-supported resin is adsorbed by the cation exchange resin, thereby enabling removal or reduction of the catalytic metal that has eluted into the treated water.

The catalytic metal-supported resin and the cation exchange resin may be packed together in the same resin tower, and the charging configuration is not particularly limited.

“Stacking” refers to the use of a catalytic metal-supported resin and one or more types of cation exchange resin in a stacked state, rather than in a mixed state, when charging a single tower with the catalytic metal-supported resin and one or more types of cation exchange resin and passing water through the tower. In the present description, the term “stacking” refers to a state in which the catalytic metal-supported resin and the cation exchange resin are stacked in this order along the flow direction of the water to be treated, while the term “multi-layer” refers to a state in which the cation exchange resin, the catalytic metal-supported resin, and the cation exchange resin are stacked in this order along the flow direction of the water to be treated.

Furthermore, the term “mixed bed” refers to a state in which the cation exchange resin and the catalytic metal-supported resin are packed in a mixed state.

When catalytic metal-supported resin and cation exchange resin are packed into the same resin tower, the cation exchange resin is packed in such an amount that the bed height is 30 cm or more.

The expression “the cation exchange resin is packed in such an amount that the bed height is 30 cm or more” means that, in the case where the catalytic metal-supported resin and the cation exchange resin are packed in a layered configuration, the height of the cation exchange resin is 30 cm or more. It is also means that, in the case where the cation exchange resin, the catalytic metal-supported resin, and the cation exchange resin are packed in this order in a layered configuration (that is, in the case of a multi-layer configuration), the height of the cation exchange resin on the downstream side of the catalytic metal-supported resin is 30 cm or more. It is also means that, in the case where the cation exchange resin and the catalytic metal-supported resin are packed as a mixture (that is, in the case of a mixed bed configuration), the height of the cation exchange resin when only the cation exchange resin is packed in the resin tower is 30 cm or more.

The term “layer height” means the stacked height of the resin that contributes to the treatment of the water to be treated in the horizontal direction with respect to the water flow direction.

As resin towers in which catalytic metal-supported resin and cation exchange resin are packed, three typical forms can be exemplified: a form having neither a water collection pipe nor a strainer, a form having a water collection pipe but no strainer, and a form having a strainer but no water collection pipe. Hereinafter, these typical forms will be described respectively with reference to the drawings.

FIG. 2 shows one embodiment of a resin tower 10 having neither a water collection pipe 16 nor a strainer 17. In FIG. 2, catalytic metal-supported resin and cation exchange resin are packed in a “stacked” form. That is, catalytic metal-supported resin 14 is stacked in an upper portion of the resin tower 10, and cation exchange resin 15 is stacked in a lower portion. Water to be treated is introduced into the upper side of the resin tower 10 and is discharged as treated water from the lower side.

In the figure, X represents the layer height of the catalyst-supported resin 14, and Y represents the layer height of the cation exchange resin 15. The cation exchange resin 15 is packed such that the layer height Y is 30 cm or more. The layer height X of the catalyst-supported resin is not particularly limited, but is preferably 10 cm or more.

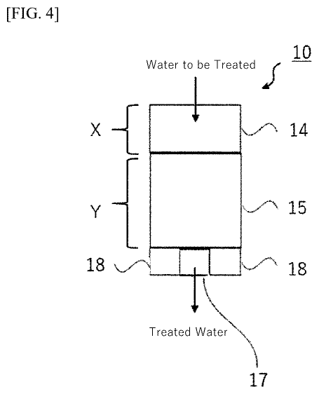

The catalytic metal-supported resin and the cation exchange resin may be packed in the form of a “multi-layer.” In this case, the catalytic metal-supported resin in a middle portion is interposed between the cation exchange resins in the upper and lower portions of the resin tower. The catalytic metal-supported resin and the cation exchange resin may also be mixed and packed in the form of a “mixed bed.” In the case of a “mixed bed, the layer height indicates the layer height when only one of the two resins packed in the resin tower 10 is packed, including the forms shown in FIG. 3 and FIG. 4 described below.

FIG. 3 shows one embodiment of a resin tower 10 having a water collection pipe 16. In FIG. 3, catalytic metal-supported resin and cation exchange resin are packed in a “stacked” form. That is, with respect to a water collection pipe 16 provided at the center from the side of the resin tower 10, catalytic metal-supported resin 14 and cation exchange resin 15 are stacked (arranged) in this order. Water to be treated is introduced from the side of the resin tower 10 and is discharged as treated water from the central water collection pipe 16.

In the figure, X represents the layer height of the catalyst-supported resin 14, and Y represents the layer height of the cation exchange resin 15. The cation exchange resin 15 is packed such that the layer height Y is 30 cm or more. The layer height X of the catalyst-supported resin is not particularly limited, but is preferably 10 cm or more.

The catalytic metal-supported resin and the cation exchange resin may be packed in the form of a “multi-layer.” In this case, from the side of the resin tower toward the center, the cation exchange resin, the catalytic metal-supported resin, and the cation exchange resin are stacked (arranged) in this order. The catalytic metal-supported resin and the cation exchange resin may also be mixed and packed in the form of a “mixed bed.”

FIG. 4 shows one embodiment of a resin tower 10 having a strainer 17. The strainer 17 is a slit-shaped member which prevents resin from flowing out of the resin tower 10 (treated water outlet) while allowing treated water to flow out, and has a slit width of 0.5 mm or less, and is disposed at the lowest stage of the resin tower 10. The resin layer in the strainer 17 portion is not used for applications requiring performance, since the contact time varies depending on the flow path. From the standpoint of cost and influence on water quality, it is preferable to pack cation exchange resin around the strainer.

In FIG. 4, the catalytic metal-supported resin and the cation exchange resin are packed in a “stacked” form. That is, from the upper side of the resin tower 10, the catalytic metal-supported resin 14 and the cation exchange resin 15 are stacked in this order, and the strainer 17 and cation exchange resin 18 are disposed at the lowermost stage. Water to be treated is introduced into the resin tower 10 from the upper side and is discharged as treated water from the lower side.

In the figure, X represents the layer height of the catalyst-supported resin 14, and Y represents the layer height of the cation exchange resin 15. The cation exchange resin 15 is packed such that the layer height Y is 30 cm or more. The layer height X of the catalyst-supported resin is not particularly limited, but is preferably 10 cm or more.

The catalytic metal-supported resin and the cation exchange resin may be packed in the form of a “multi-layer.” In this case, from the upper side of the resin tower, the cation exchange resin, the catalytic metal-supported resin, and the cation exchange resin are stacked in this order. The catalytic metal-supported resin and the cation exchange resin may also be mixed and packed in the form of a “mixed bed.”

The catalytic metal-supported resin is one in which a platinum catalyst having high hydrogen peroxide removal performance is supported on an anion exchange resin as a carrier. The supported platinum catalyst decomposes hydrogen peroxide generated by ultraviolet irradiation into water and oxygen according to the reaction 2H₂O₂→2H₂O+O₂. An anion exchange resin is preferable as the carrier of the catalytic metal-supported resin.

Examples of platinum group metals include, for example, platinum (Pt), palladium (Pd), ruthenium (Ru), rhodium (Rh), osmium (Os), and iridium (Ir), and any one of these may be used alone, or two or more thereof may be used in combination. Among these platinum group metals, Pt and Pd are preferable, and Pd is more preferable from the standpoint of catalytic activity.

Furthermore, as the anion exchange resin serving as the carrier, a gel type is preferable in view of being able to suppress elution of total organic carbon (TOC) components from the anion exchange resin. In addition, from the viewpoint of good contact efficiency with hydrogen peroxide, it is more preferable that the R-OH is 60% or more, particularly 95% or more. The same applies to the catalytic metal-supported resin.

Furthermore, although the anion exchange resin may contain some weakly basic anion exchange resin, it is preferable that it is composed only of strongly basic anion exchange resin, since the strongly basic anion exchange resin has a higher basicity than the weakly basic anion exchange resin and can more effectively promote decomposition of hydrogen peroxide.

Also, the catalyst loading amount is preferably 10 mg-catalyst/L-R or more and 500 mg-catalyst/L-R or less. When it is 10 mg catalyst/L-R or more, peroxides can be sufficiently removed, whereas when it exceeds 500 mg-catalyst/L-R, problems such as increase in cost may occur.

There are no particular restrictions on the size and shape of the catalyst carrier, and both granular and pellet forms can be used.

There are no particular limitations on the method for supporting the catalytic metal on the anion exchange resin, but, for example, there is a method in which a solution of hexachloroplatinic acid, palladium chloride, or the like is passed through the anion exchange resin, and then a reducing agent such as formalin is passed through to support the catalytic metal.

As the cation exchange resin to be packed into the resin tower together with the catalytic metal-supported resin, a gel-type resin is preferable to an MR-type resin in view of elution, and it is preferable that the R-H is 90% or more.

The water flow rate of the water to be treated through the resin tower is preferably in the range of SV=30 to 2000 h⁻¹. The catalyst resin of this embodiment has high hydrogen peroxide decomposition efficiency, and therefore even if the water space velocity SV of the water to be treated through the catalyst resin is increased, it exhibits high hydrogen peroxide removal performance. Normally, when a water space velocity SV is less than 30 hr⁻¹, in the production of ultrapure water, elution of impurities from the resin may increase, which is undesirable. Furthermore, when the water space velocity SV exceeds 2000 hr⁻¹, the pressure loss during water flow becomes excessive. The direction in which the water to be treated flows through the resin tower 10 required to be such that a cation exchange resin is present at the final liquid contact portion. As long as a cation exchange resin is present at the final liquid contact portion, the water flow direction may be either downward or upward, regardless of whether the resin is arranged in a layered bed, a multi-layer bed, or mixed bed, and there is no restriction on the water flow direction.

Next, the configuration of the water treatment apparatus of the present invention will be described in detail with reference to the drawing.

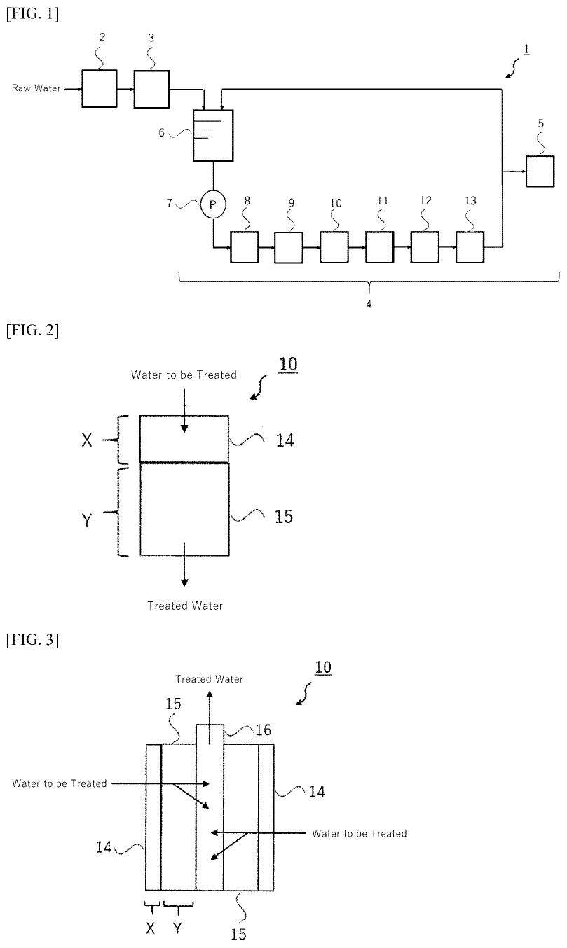

FIG. 1 is a schematic diagram of an ultrapure water production apparatus according to one embodiment of the present invention. It should be noted that the configuration of the ultrapure water production apparatus shown in the figure is merely an example, and the present invention is not limited thereto.

The water treatment apparatus 1 includes a pretreatment system 2, a primary pure water production system 3, and a secondary pure water production system (subsystem) 4.

The pretreatment system 2 is provided with, for example, a coagulation device, a pressure flotation (sedimentation) device, and a filtration device (not shown), and produces filtered water from raw water. The primary pure water production system 3 is provided with, for example, an ion exchange device, a reverse osmosis membrane device, a vacuum degassing device, and a regenerative ion exchange device (such as a mixed bed type, a two-bed three-tower type, or four-bed five-tower type) (not shown), and produces primary pure water (pure water) from the filtered water produced in the pretreatment system 2.

The secondary pure water production system 4, also called a subsystem, uses the pure water produced in the primary pure water production system 3 as water to be treated, produces secondary pure water (ultrapure water), and supplies the ultrapure water to a use point 5.

The subsystem 4 has a sub-tank (primary pure water tank) 6, a pump 7, a heat exchanger 8, an ultraviolet oxidation device 9, a hydrogen peroxide removal device (resin tower) 10, a deoxidation device 11, a non-regenerative mixed-bed ion exchange device (cartridge polisher) 12, and a fine particle separation membrane device 13. These devices 6 to 13 are arranged in this order from upstream to downstream along the flow direction of the water to be treated.

If necessary, the water treatment apparatus 1 may be provided with a wastewater treatment device (not shown) that treats wastewater generated during the water treatment process.

As mentioned above, the resin tower 10 is packed with a catalytic metal-supported resin in which a platinum catalyst is supported on a carrier of an anion exchange resin, and a cation exchange resin.

In the subsystem 4, the water to be treated (primary pure water) stored in the sub-tank 6 is delivered by the pump 7 and supplied to the heat exchanger 8. The water to be treated, whose temperature has been adjusted by passing through the heat exchanger 8, is supplied to the ultraviolet oxidation device 9 where it is irradiated with ultraviolet light, and the total organic carbon (TOC) in the water to be treated is decomposed. When the water to be treated is irradiated with ultraviolet light, hydrogen peroxide is generated. After ultraviolet irradiation, the water to be treated containing the peroxide (hydrogen peroxide-containing water) is supplied to the resin tower 10, where the hydrogen peroxide is decomposed into water and oxygen by a platinum catalyst supported on a carrier of an anion exchange resin. When the water to be treated is passed through the catalytic metal-supported resin, the catalytic metal is eluted into the treated water, but it is adsorbed by a cation exchange resin packed in the same resin tower, whereby the catalytic metal eluted into the treated water can be removed or reduced.

The water treated in the resin tower 10 is supplied to a deoxidizer 11, where oxygen generated by decomposition of hydrogen peroxide is removed. Subsequently, the water treated in the deoxidizer 11 is supplied to a cartridge polisher 12, where metals and the like are removed by ion exchange treatment. In FIG. 1, the cartridge polisher 12 is arranged downstream of the deoxidizer 11; however, since the purpose of the deoxidizer 11 is to remove dissolved oxygen, it is sufficient that the deoxidizer 11 is provided downstream of the resin tower 10. For example, the deoxidizer 11 may be arranged downstream of the cartridge polisher 12.

The water treated in the cartridge polisher 12 is then supplied to a particulate separation membrane device 13, where particles are removed.

The ultrapure water thus obtained is supplied to the use point 5, and the remainder is returned to the sub-tank 6. Primary pure water is supplied to the sub-tank 6 from the primary pure water production system 3 as necessary.

The ultraviolet oxidation device 9 is provided with an ultraviolet lamp capable of irradiating the water to be treated (primary pure water) with ultraviolet rays having a wavelength of around 100 to 200 nm, and oxidatively decomposes organic matter in the water to be treated. The organic matter is decomposed into organic acids and further into CO₂ by oxidation. The ultraviolet oxidation device 9 is preferably provided with an ultraviolet lamp capable of irradiating ultraviolet rays having a wavelength of around 185 nm, for example. There are no particular limitations on the ultraviolet lamp used in the ultraviolet oxidation device 9 or the like, but a low-pressure mercury lamp is preferable, for example. Further, ultraviolet oxidation devices include a flow-through type and an immersion type, but the flow-through type is preferable with respect to treatment efficiency.

Any deoxygenation device 11 may be used as long as it can remove oxygen (O₂) dissolved in water. Examples include vacuum degassing devices, membrane degassing devices, and nitrogen degassing devices. These vacuum degassing devices, membrane degassing devices, and nitrogen degassing devices reduce the concentration of dissolved oxygen in water and simultaneously remove volatile organic compounds and carbon dioxide into the gas phase, thereby reducing the concentrations of these substances in the water. For example, a membrane degassing device is a device in which the treated water that has been treated in the resin tower 10 is supplied to one chamber separated by a gas separation membrane, and the other chamber is depressurized, whereby gases contained in the treated water, such as oxygen in the present invention, migrate through the gas separation membrane to the other chamber and are removed. As the gas separation membrane, for example, a hydrophobic polymer membrane such as a tetrafluoroethylene-based membrane or a polyolefin-based membrane formed into a hollow fiber membrane or other shape may be used.

Another example of the deoxygenation device 11 may be one that removes oxygen by adding hydrogen (H₂) and reacting the oxygen with the hydrogen using a palladium (Pd) catalyst to form water.

The addition of hydrogen is preferably carried out upstream of the resin tower 10. In this case, the removal of oxygen by the deoxygenation device 11 downstream thereof may be omitted, or oxygen removal using the catalytic reaction may be used in combination with oxygen removal by the deoxygenation device 11.

The cartridge polisher 12 is not particularly limited as long as it is capable of removing impurities such as cations and anions contained in the water to be treated, but examples include an ion exchange device employing a mixed bed of a strongly acidic cation exchange resin and strongly basic anion exchange resin (mixed bed single tower type).

The particle separation membrane device 13 is not particularly limited as long as is capable of removing particles and the like flowing out from the cartridge polisher 12 and the like, but an example is a device using an ultrafiltration membrane as the particle separation membrane.

In addition, as the coagulation device, the pressure flotation (sedimentation) device, the filtration device, and the like that constitute the pretreatment system 2; the ion exchange device, the reverse osmosis membrane device, the vacuum degassing device, the regenerative ion exchange device, and the like that constitute the primary pure water system; and the sub-tank 6, the pump 7, and the heat exchanger 8 that constitute the subsystem, devices that are generally used in ultrapure water production apparatus provided in the subsystem may be used.

According to the above configuration, it is possible to remove or reduce the catalytic metal that has eluted into the treated water from the catalytic metal-supported resin packed in the resin tower 10, and to obtain high-purity ultrapure water from which organic matter, hydrogen peroxide, dissolved gases (such as oxygen and carbon dioxide), ionic substances (impurities), and fine particles have been removed.

The ultrapure water obtained by this embodiment is suitable for cleaning electronic components and equipment for manufacturing electronic components.

### EXAMPLES

### Example 1

An ion exchange resin container (column) having an inner diameter of 22 mm and a height of 1 m was packed by stacking 38 mL (bed height 10 cm) of a catalytic metal-supported resin (Cat.) at the inlet side of the column and 304 mL (bed height 80 cm) of a cation exchange resin (CER) at the outlet side of the column, to a total bed height of 90 cm. ORLITE HR43-HG (manufactured by ORGANO CORPORATION) was used as the catalytic metal-supported resin, and AMBERJET ESP-K (manufactured by ORGANO CORPORATION) was used as the cation exchange resin. The R-OH of the catalytic metal-supported resin and its carrier resin used was R-OH >95%. The R-H of the cation exchange resin was R-H≥90%.

Ultrapure water was passed through this column at a space velocity SV of 50/h. The resistivity of this ultrapure water was 18.2 MΩ·cm as measured using an 875CR manufactured by FOXBOR, the TOC was ≤1.0 μg/L as measured using an A-1000XP manufactured by Anatel, and the concentration of the catalytic metal was ≤1 pq/L as measured using an ICP-MS manufactured by Agilent by the monolith concentration method.

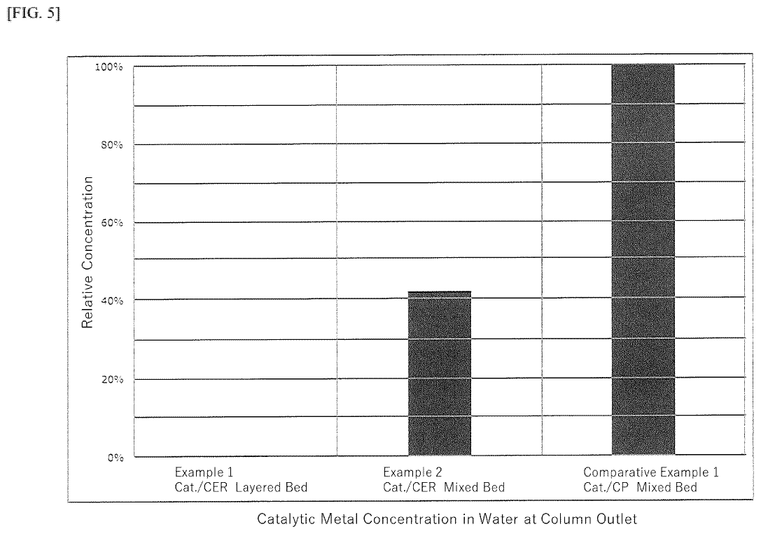

Two weeks after the water was passed through, the water at the outlet of the column was sampled in accordance with the method of Comparative Example 1 of WO 2022/102326 A1, and the concentration of the catalytic metal was measured using an ICP-MS 8900 manufactured by Agilent. The results are shown in FIG. 5. Note that FIG. 5 shows the results based on Comparative Example 1.

### Example 2

The catalytic metal concentration in the water at the outlet of the column was measured in the same manner as in Example 1, except that 38 mL of catalytic metal-supported resin (Cat.) and 304 mL of cation exchange resin (CER) were packed into the column as a mixed bed to a bed height of 90 cm. The catalytic metal-supported resin and the cation exchange resin used were the same as those used in Example 1. The results are shown in FIG. 5.

### Comparative Example 1

The catalytic metal concentration in the water at the outlet of the column was measured in the same manner as in Example 2, except that 38 mL of catalytic metal-supported resin (Cat.) and 304 mL of non-regenerated mixed-bed ion exchange resin (CP) were packed into the column as a mixed bed to a bed height of 90 cm. The non-regenerated ion exchange resin used was AMBERJET ESP-2 (manufactured by ORGANO CORPORATION). The results are shown in FIG. 5.

### Reference Example 1

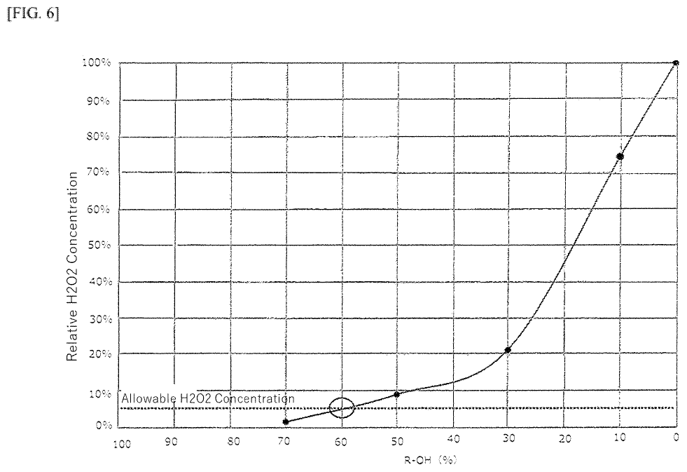

Water to be treated with an H₂O₂ content of 35 μg/L was prepared. Separately, a column was prepared by packing 38 mL of the same catalytic metal-supported resin (Cat.) as in Example 1 (layer height 10 cm) into the same column as in Example 1. The water to be treated was then passed through the column at a water flow rate of 425 h⁻¹,SV, and one week after the start of water flow, the relationship between the R-OH (%) of the catalytic metal-supported resin (carrier resin) and the H2O₂ decomposition efficiency was evaluated. The results are shown in FIG. 6.

From FIG. 5, it was confirmed, by comparing Example 2 with Comparative Example 1, that the catalytic metals in the treated water were more removed/reduced in Example 2 than in Comparative Example 1. This demonstrated that, when a larger amount of cation exchange resin was packed into the same tower together with the catalytic metal-supported resin, the catalytic metals were more removed/reduced.

Furthermore, by comparing the Examples, it was confirmed that Example 1 removed/reduced more catalytic metals in the treated water than Example 2. This demonstrated that the packed state in which charging the catalytic metal-supported resin and cation exchange resin were stacked removed/reduced more catalytic metals than the mixed bed. This is considered to be because, in the mixed bed, more catalytic metal-supported resin existed at the final stage of liquid contact than in the stacked state.

Furthermore, FIG. 6 demonstrates that sufficient H2O₂ decomposition efficiency can be achieved when the R-OH of the catalytic metal-supported resin (carrier resin) is 60% or more.

The present invention has been described above with reference to exemplary embodiments; however, the present invention is not limited to the above embodiments. Various modifications, which can be made by those skilled in the art, may be applied to the configurations and details of the present invention within the scope of the invention.

This application claims priority to Japanese Patent Application No. 2023-076093, filed on May 2, 2023, the entire disclosure of which is hereby incorporated by reference.

### EXPLANATION OF REFERENCE SIGNS

1 Water treatment apparatus
2 Pre-treatment system
3 Primary pure water production system
4 Secondary pure water production system (subsystem)
5 Use point
6 Subtank
7 Pump
8 Heat exchanger
9 Ultraviolet oxidation device
10 Hydrogen peroxide removal device (resin tower)
11 Deoxygenation device
12 Non-regenerative mixed bed ion exchange device (cartridge polisher)
13 Particulate separation membrane device
14 Catalytic metal-supported resin
15 Cation exchange resin
16 Water collection pipe
17 Strainer
18 Cation exchange resin
X: Layer height of catalytic metal-supported resin
Y: Layer height of cation exchange resin

1. A hydrogen peroxide treatment device provided with a hydrogen peroxide removal means for removing hydrogen peroxide from water to be treated,
wherein the hydrogen peroxide removal means comprises a resin tower packed with a catalytic metal-supported resin in which a platinum group metal catalyst is supported on an anion exchange resin carrier, and a cation exchange resin, and wherein an amount of the cation exchange resin packed in the resin tower corresponds to a layer height of 30 cm or more.

2. The hydrogen peroxide treatment device according to claim 1, wherein the catalytic metal-supported resin and the cation exchange resin are stacked and packed in this order in the resin tower in the direction of flow of the water to be treated.

3. The hydrogen peroxide treatment device according to claim 1, wherein the cation exchange resin, the catalytic metal-supported resin, and the cation exchange resin are stacked and packed in this order in the resin tower in the direction of flow of the water to be treated.

4. The hydrogen peroxide treatment device according to claim 1, wherein the catalytic metal-supported resin and the cation exchange resin are mixed and packed in the resin tower.

5. The hydrogen peroxide treatment device according to claim 1, wherein the anion exchange resin serving as a carrier has an R-OH of 60%, and the amount of catalytic metal carried is in a range of 10 mg-catalyst/L-R to 500 mg-catalyst/L-R.

6. The hydrogen peroxide treatment device according to claim 1, wherein the catalytic metal-supported resin is gel type.

7. A water treatment apparatus comprising a primary pure water production system and a secondary pure water production system,
wherein the secondary pure water production system comprises the hydrogen peroxide treatment device according to claim 1, and
an ultraviolet oxidation device provided upstream of the hydrogen peroxide treatment device; and
wherein hydrogen peroxide-containing water to be treated by the hydrogen peroxide treatment device is the treated water treated by the ultraviolet oxidation device.

8. A hydrogen peroxide treatment method for treating hydrogen peroxide in water to be treated using a hydrogen peroxide treatment device provided with a hydrogen peroxide removal means for removing hydrogen peroxide,
wherein the hydrogen peroxide removal means comprises a resin tower packed with a catalytic metal-supported resin in which a platinum group metal catalyst is supported on an anion exchange resin carrier, and a cation exchange resin, and wherein an amount of the cation exchange resin packed in the resin tower corresponds to a layer height of 30 cm or more.

9. The hydrogen peroxide treatment method according to claim 8, wherein hydrogen is added to the water to be treated upstream of the resin tower.

10. A water treatment method comprising treating water to be treated in the order of a primary pure water production system and a secondary pure water production system,
wherein the secondary pure water production system comprises the hydrogen peroxide treatment device according to claim 1, and
an ultraviolet oxidation device provided upstream of the hydrogen peroxide treatment device; and
wherein hydrogen peroxide-containing water to be treated by the hydrogen peroxide treatment device is the treated water treated by the ultraviolet oxidation device.
